(19) United States
(12) Patent Application Publication
(10) Pub. No.: US 2018/0025659 A1
(43) Pub. Date: Jan. 25, 2018

(54) Electronic Manual with Cross-Linked Text and Virtual Models

(71) Applicant: SHARP VISION SOFTWARE, LLC, KATY, TX (US)

(72) Inventor: Win Liu, KATY, TX (US)

(73) Assignee: SHARP VISION SOFTWARE, LLC, KATY, TX (US)

(21) Appl. No.: 15/655,627

(22) Filed: Jul. 20, 2017

Related U.S. Application Data
(60) Provisional application No. 62/365,671, filed on Jul. 22, 2016.

(51) Int. Cl. G09B 5/06; G06F 3/0484; G09B 25/02; G06F 3/0483; G06F 17/22; G06T 19/20

(52) U.S. Cl. CPC G09B 5/065; G06F 17/2235; G06T 19/20; G09B 25/02; G06F 3/0483; G06F 3/04845; G06F 2203/04806

(57) ABSTRACT

A method of providing an electronic manual with three-dimensional (3D) virtual models includes instructions executed by a processor and includes retrieving an electronic manual from a memory device and displaying the electronic manual on a display interface of a display device, where the electronic manual includes a textual instruction section and a virtual model section and where the virtual model section includes a 3D virtual model of an object. The method includes receiving, by a user interface of the display device, a user input selecting a linked text displayed in the textual instruction section, identifying a component of the object in the 3D virtual model that is linked to the linked text, and highlighting, in response to identifying the component of the object in the 3D virtual model, the component of the object in the 3D virtual model displayed on display interface of the display device.

### CROSS REFERENCE TO RELATED APPLICATIONS

The present application claims priority under 35 U.S.C. Section 119(e) to U.S. Provisional Patent Application No. 62/365,671, filed Jul. 22, 2016 and titled “Electronic Manual With Cross-Linked Text And Virtual Models,” the entire content of which is incorporated herein by reference.

### TECHNICAL FIELD

The present disclosure relates generally to electronic manuals, and more particularly to manuals with text that is cross-linked with three dimensional virtual models.

### BACKGROUND

Instruction manuals for installing, repairing, assembling, etc. of an item (e.g., home appliance, furniture, engine, heavy machinery, etc.) are often provided in printed form or in electronic form. Other kinds of manuals such as training manuals are also often provided in a printed or electronic form. Generally, the drawings in these manuals are provided in two-dimensional (2D) form. Further, a user of such manuals has to often manually search in the drawings the different components of an object being installed, repaired, assembled, etc. based on instructions provided in the manual. When instructions in a manual are provided on different pages from the relevant drawings, following the instructions with respect to the drawings may be even more challenging and time consuming. Further, manually searching for parts of instructions in a manual that are relevant to a particular component shown in a drawing may be time consuming. Thus, a solution that facilitates the use of manuals, such as instructions manual, is desirable.

### SUMMARY

The present disclosure relates generally to electronic manuals, and more particularly to manuals with text that is cross-linked with three dimensional virtual models. In an example embodiment, a non-transitory computer-readable medium that includes instructions that when executed by a processor display an electronic manual on a display interface of a display device, where the instructions include retrieving an electronic manual from a memory device and displaying the electronic manual on a display interface of a display device. The electronic manual includes a textual instruction section and a virtual model section, where the virtual model section includes a 3D virtual model of an object. The instructions further include receiving from an input interface device a user input selecting a linked text displayed in the textual instruction section and identifying, in response to receiving the user input selecting the linked text, a component of the object in the 3D virtual model that is linked to the linked text, and highlighting, in response to identifying the component of the object in the 3D virtual model, the component of the object in the 3D virtual model displayed on display interface of the display device.

In another example embodiment, a method of providing an electronic manual with three-dimensional (3D) virtual models, where the method is performed by a computer-readable modeling engine including instructions executed by a processor and includes retrieving, by the computer-readable modeling engine, an electronic manual from a memory device and displaying, by the computer-readable modeling engine, the electronic manual on a display interface of a display device, where the electronic manual includes a textual instruction section and a virtual model section and where the virtual model section includes a 3D virtual model of an object. The method further includes receiving, by a user interface of the display device, a user input selecting a linked text displayed in the textual instruction section, identifying by the computer-readable modeling engine, in response to receiving the user input selecting the linked text, a component of the object in the 3D virtual model that is linked to the linked text, and highlighting by the computer-readable modeling engine, in response to identifying the component of the object in the 3D virtual model, the component of the object in the 3D virtual model displayed on display interface of the display device.

In another example embodiment, a method of providing an electronic manual with three-dimensional (3D) virtual models, where the method is performed by a computer-readable modeling engine comprising instructions executed by a processor and includes retrieving, by the computer-readable modeling engine, an electronic manual from a memory device, displaying, by the computer-readable modeling engine, the electronic manual on a display interface of the display device, where the electronic manual includes a textual instruction section and a virtual model section and where the virtual model section includes a 3D virtual model of an object. The method further includes receiving, by a user interface of the display device, a user input selecting a component of the object in the 3D virtual model, identifying by the computer-readable modeling engine, in response to receiving the user input selecting the component of the object in the 3D virtual model, a linked text in the textual instruction section that is linked to the component of the object in the 3D virtual model, and highlighting, by the computer-readable modeling engine, in response to identifying the component of the object in the 3D virtual model, the linked text in the textual instruction section displayed on display interface of the display device.

These and other aspects, objects, features, and embodiments will be apparent from the following description and the appended claims.

### BRIEF DESCRIPTION OF THE FIGURES

Reference will now be made to the accompanying drawings, which are not necessarily drawn to scale, and wherein:

FIG. 1 illustrates an electronic manual including textual instructions cross-linked with an interactive three-dimensional virtual model of an object according to an example embodiment;

FIG. 2 illustrates the electronic manual of FIG. 1 with a component of the object highlighted in the interactive three-dimensional virtual model in response to selection in the textual instructions according to an example embodiment;

FIG. 3 illustrates the electronic manual of FIG. 2 with the object manipulated to a different position by a user according to an example embodiment;

FIG. 4 illustrates the electronic manual of FIG. 1 with occurrences of the linked text in the textual instruction highlighted in response to a user selection in the interactive three-dimensional virtual model according to an example embodiment;

FIG. 5 illustrates an interactive three-dimensional virtual model of an object that is displayed in response to recognizing the object from a two-dimensional model according to an example embodiment; and

FIG. 6 illustrates a device for providing the electronic manual of FIG. 1 according to an example embodiment.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the drawings, reference numerals that are used with respect to different drawings designate like or corresponding, but not necessarily identical elements.

### DETAILED DESCRIPTION OF THE EXAMPLE EMBODIMENTS

In the following paragraphs, example embodiments will be described in further detail with reference to the figures. In the description, well known components, methods, and/or processing techniques are omitted or briefly described. Furthermore, reference to various feature(s) of the embodiments is not to suggest that all embodiments must include the referenced feature(s).

The present disclosure describes an electronic manual and method of using the electronic manual for providing instructions on operating on physical objects including mechanical systems, electronic devices, and any other types of physical objects using interactive three-dimensional virtual models of the physical objects.

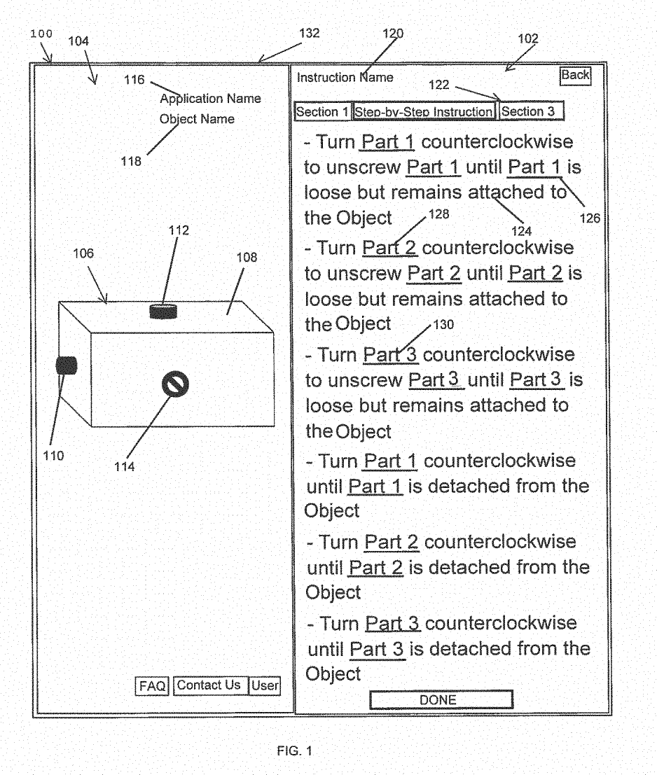

Turning now to the figures, particular example embodiments are described. FIG. 1 illustrates an electronic manual 100 including a textual instruction section 102 cross-linked with an interactive three-dimensional virtual model section 104 of an object 106 according to an example embodiment. In some example embodiments, the electronic manual 100 includes the textual instruction section 102 that is displayed on one side of a display device 132 and the virtual model section 104 that is displayed on another side of the display device 132. The display device 132 may be a desktop computer with a monitor, a laptop, a tablet, or another suitable device as can be understood by those of ordinary skill in the art with the benefit of this disclosure. In some example embodiments, the textual instruction section 102 may be displayed on a right side and the virtual model section 104 may be displayed on the left side as shown in FIG. 1. Alternatively, the textual instruction section 102 and the virtual model section 104 may be displayed in different relative positions than shown in FIG. 1 without departing from the scope of this disclosure.

As illustrated in FIG. 1, the textual instruction section 102 may include texts 124 that include linked texts 126, 128, 130 that are linked with components in the virtual model section 104. For example, the linked text 126 may be a part name, Part 1, the linked text 128 may be a part name, Part 2, and the linked text 130 may be a part name, Part 3. The linked texts 126, 128, 130 may be formatted (e.g., underlined, bold, etc.) to distinguish the linked texts 126, 128, 130 from other texts that are not linked with components in the virtual model section 104. Alternatively, linked texts 126, 128, 130 may not have a formatting that is different from other texts.

In some example embodiments, the textual instruction section 102 may also include Instruction Name 120 that provides the specific name of a manual or a section of a manual. For example, the Instruction Name 120 may be Container Assembly or another applicable name. The textual instruction section 102 may also include selectable tabs 122 that result, upon selection by a user, in a selected section of the manual being displayed in the textual instruction section 102.

In some example embodiments, the virtual model section 104 includes a virtual 3D model of an illustrative object 106. Instructions applicable to the object 106 may be displayed in the textual instruction section 102, where, for example, a user may follow the instructions to operate on a physical object represented by the object 106 displayed in the virtual model section 104. For example, the textual instruction section 102 may display assembly, disassembly, repair, etc. instructions related to the object 106. By following the instructions displayed in the textual instruction section 102, a user may disassemble, assemble, repair, or otherwise work on the physical object represented by the object 106 displayed in the virtual model section 104.

In some example embodiments, the electronic manual 100 may also include Application Name 116 and Object Name 118 that are displayed, for example, along with or in the virtual model section 104. For example, the Application Name 116 may be a specific name of software product that is used to display the electronic manual 100. The Object Name 118 may be the name of the object 106. For example, a Container, Engine, Dishwasher, etc. or a specific name and model information may be displayed as the Object Name 118.

In some example embodiments, the object 106 may include a housing 108, a first component 110, a second component 112, and a third component 114. In response to a selection of a particular component of the object 106 in the textual instruction section 102, the corresponding component of the object 106 displayed in the virtual model section 104 may be highlighted or otherwise identified. For example, a component of the object 106 may be highlighted in the virtual model section 104 by changing the color of the component, or by other means as may be contemplated by those of ordinary skill in the art with the benefit of this disclosure. The linked text 126 in the textual instruction section 102 may be linked with the first component 110 of the object 106 in the virtual model section 104, the linked text 128 in the textual instruction section 102 may be linked with the second component 112, and the linked text 130 in the textual instruction section 102 may be linked with the third component 114. When a user selects the linked text 126 in the textual instruction section 102, the first component 110 may be highlighted in the virtual model section 104. The selected linked text 126 and other occurrences of the linked text 126 in the textual instruction section 102 may also be highlighted, indicating that the linked text 126 in the textual instruction section 102 corresponds to the first component 110 that is highlighted in the virtual model section 104.

As another example, when a user selects the linked text 128, the second component 112 may be highlighted in the virtual model section 104 along with occurrences of the linked text 128 highlighted in the textual instruction section 102. As yet another example, when a user selects the linked text 130, the third component 114 may be highlighted in the virtual model section 104 along with occurrences of the linked text 130 highlighted in the textual instruction section 102. Each linked text 126, 128, 130 may be highlighted by changing its font, by changing its color, by placing a box around it, or by other means as may be contemplated by those of ordinary skill in the art with the benefit of this disclosure.

In some example embodiments, a user may select one of the linked texts 126, 128, 130 using a cursor controlled by a mouse attached to the display device 132. Alternatively or in addition, the display device 132 may have a touch-screen display, and a user may select the linked text by touching the linked text of the textual instruction section 102 displayed on the screen. In some alternative embodiments, a user may select the linked texts 126, 128, 130 using another means as may be contemplated by those of ordinary skill in the art with the benefit of this disclosure.

The linked text 126, 128, 130 in the textual instruction section 102 may be linked with corresponding components of the object 106 of the virtual model section 104 using methods similar to use of hyperlinks in HTML (HyperText Markup Language). Components touch/click methods are defined in the virtual reality environment and are called in HTML/JavaScript code to implement the link between the textual instruction section 102 and the object 106 of the virtual model section 104.

In some example embodiments, when a particular linked text is selected by a user on the textual instruction section 102, the object 106 in the virtual model section 104 may, in response, be tilted and/or rotated to provide a better view of the component of the object 106 that is linked with the selected linked text in the textual instruction section 102. For example, when the linked text 126 is selected by a user in the textual instruction section 102, the first component 110 may be highlighted and the object 106 in the virtual model section 104 may be rotated and/or tilted so that the first component 110 is more clearly visible to the user. To illustrate, selecting a particular linked text in the textual instruction section 102 that is linked with a component of the object 106 that is out of view in the virtual model section 104 may bring the component into view in the virtual model section 104. For example, if the component 110 is out of view in a particular orientation of the object 106 as displayed in the virtual model section 104, selecting the linked text 126 in the textual instruction section 102 may result in the object 106 being rotated and/or tilted in the virtual model section 104 such that the component 110 is in view.

In some example embodiments, when a particular linked text is selected by a user on the textual instruction section 102, a zoomed in view of the component of the object 106 that is linked with the selected linked text may be presented in the virtual model section 104. For example, when the linked text 126 is selected by a user in the textual instruction section 102, a zoomed in view of the object 106 may be presented in the virtual model section 104 to provide a close up view of the first component 110.

The tilting, rotating, highlighting, zooming, and other similar operations performed on the virtual model section 104 in response to the selection of a linked text in the textual instruction section 102 may be performed, for example, by executing software code as in Unity3D. In general, the tilting, rotating, highlighting, zooming, and other similar operations may be performed in other manners as may be contemplated by those of ordinary skill in the art with the benefit of this disclosure.

In some example embodiments, the selected linked text in the textual instruction section 102 may be unselected by a user using a mouse, touch screen input, or a similar means. Upon deselection of a linked text, the highlighting of the linked component of the object 106 in the virtual model section 104 is removed. In some example embodiments, the object 106 in the virtual model section 104 may remain in the view presented at the time that the related linked text is deselected. Alternatively, the object 106 in the virtual model section 104 may be presented in a default view upon the deselection of the linked text that is linked with the component of the object 106.

In some example embodiments, selecting a component of the object 106 in the virtual model section 104 can result in the selected component in the virtual model section 104 and occurrences of the corresponding linked text in the textual instruction section 102 being highlighted. For example, selecting the first component 110 of the object 106 in the virtual model section 104 can result in the first component 110 in the virtual model section 104 and occurrences of the linked text 126 in the textual instruction section 102 being highlighted. The selection of a component of the object 106 in the virtual model section 104 may be performed in the same manner (e.g., using a mouse) as the selection of a linked text in the textual instruction section 102. A selected component of the object 106 may also be deselected in a similar manner resulting in the removal of the highlighting of the component and corresponding linked text.

As illustrated in FIG. 1, in some example embodiments, several occurrences of a linked text displayed in the textual instruction section 102 may be linked to the same component in the virtual model section 104. For example, several occurrences of the linked text “Part 2,” designated linked text 128, may be linked to the second component 112 in the virtual model section 104 such that selecting one of the occurrences of “Part 2” or selecting the second component 112 may result in all occurrences of Part 2” being highlighted in the textual instruction section 102.

By cross-linking the three-dimensional virtual model of the object 106 displayed in the virtual model section 104 with the instructions displayed in the textual instruction section 102, a user can perform tasks, such as repairing the physical object represented by the object 106, for efficiently. The cross-linking of the three-dimensional virtual model of the object 106 with the instructions in the textual instruction section 102 enables faster identification of components that are referred to in instruction manuals. The identification (e.g., by highlighting) of a component of the object 106 displayed in the virtual model section 104 in response to the selection of a linked text in the textual instruction section 102 enables a user to more quickly relate the instructions to the physical component of the physical object represented by the object 106.

In some alternative embodiments, more or fewer linked texts than shown in FIG. 1 may be included in the textual instruction section 102. Although the electronic manual 100 is described with respect to the linked text 126, 128, 130, the textual instruction section 102 may include other linked texts. For example, some linked texts may be linked to areas of the object 106, internal components of the object 106, etc. Although the object 106 is shown in FIG. 1, a virtual 3D model of a different object may be displayed in the virtual model section 104 without departing from the scope of this disclosure. For example, the virtual model section 104 may include a virtual 3D model of furniture, an engine, a car, a building, heavy machinery, etc. without departing from the scope of this disclosure. In some example embodiments, multiple objects may be displayed in the virtual model section 104. The particular instruction steps displayed in the textual instruction section 102 and the associated formatting are for illustrative purposes, and other instructions, information, etc. with same or different formatting may instead be displayed in the textual instruction section 102.

In some alternative embodiments, the Application Name 116, the Object Name 118, the Instruction Name 120, tabs 122, etc. may appear at different locations than shown without departing from the scope of this disclosure. In some alternative embodiments, the electronic manual 100 may include displayed information and responsive buttons other than or in addition to those shown in FIG. 1 without departing from the scope of this disclosure.

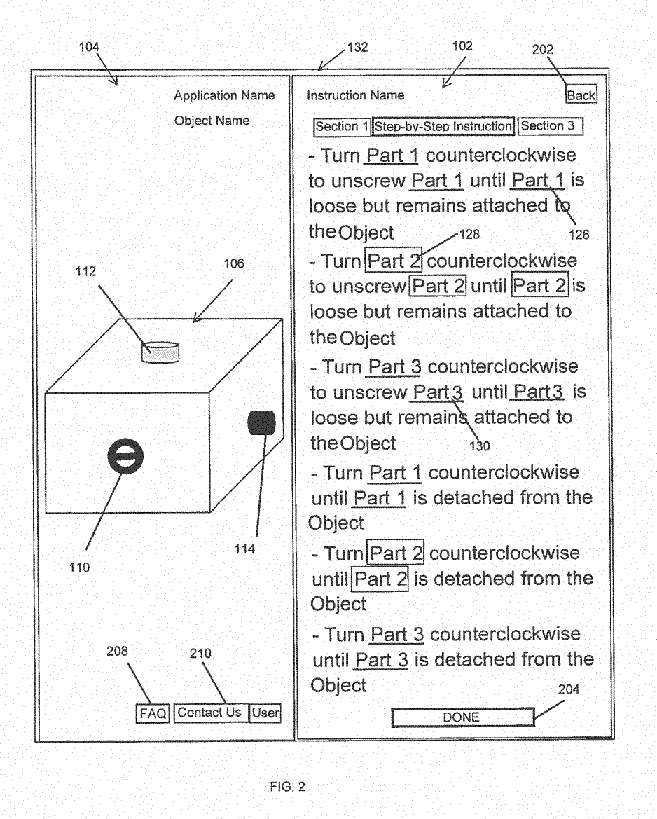

FIG. 2 illustrates the electronic manual 100 of FIG. 1 with the component 112 of the object 106 highlighted in the interactive three-dimensional virtual model section 104 according to an example embodiment. For example, the component 112 of the object 106 may be highlighted in response to a selection of the linked text 128 in the textual instruction section 102 by a user. As illustrated in FIG. 2, other occurrences of the linked text 128 in the textual instruction section 102 are also highlighted. Further, in contrast to the orientation of the object 106 in FIG. 1, in FIG. 2, the object 106 in the virtual model section 104 is rotated, and the component 112 is zoomed in in contrast to the view provided in FIG. 1. For example, the object 106 in the virtual model section 104 may be displayed as shown in FIG. 2 as a result of the selection of the linked text 128 and without further manual manipulation by the user.

Using the electronic manual 100, a person attempting to perform a task (e.g., repair, etc.) on the physical object represented by the object 106 can more readily follow the instructions provided in the textual instruction section 102 because of the identification of the components of the object 106 in the virtual model section 104 in response to selection of the respective linked texts in the textual instruction section 102. For example, because the component 112 is highlighted in the virtual model section 104 in response to a user selecting linked text 128 in the textual instruction section 102, the user can more readily follow the follow instructions related to the linked text 12. Other components of the object 106 in the virtual model section 104 may also be identified in a similar manner facilitating performance of tasks on the physical object represented by the object 106.

In some example embodiments, the textual instruction section 102 may include user selectable buttons, such as a Back button 202 and a Done button 204. For example, a user may return to a previous page of the textual instruction section 102 by selecting (e.g., clicking) the Back button 202. A user may also be able to move to a next section or page of the textual instruction section 102 by selecting the Done button 204. For example, changing the page of the textual instruction section 102, for example by selecting a new section of a manual, may result in another object that is relevant to the new page of the textual instruction section 102 being displayed in the virtual model section 104.

In some example embodiments, the electronic manual 100 may also include an FAQ button 208 and a Contact Us button 210. For example, when a user selects the FAQ button 208, a window may pop up providing with information to facilitate understanding of the instructions provided by the electronic manual 100. Further, a user may select (e.g., click) the Contact Us button 210 to seek further help in understanding the instructions via text, audio call, and video conference with the support providing party. For example, the display device 132 may include a camera, a microphone and/or a speaker.

In some example embodiments, the selected linked text 128 in the textual instruction section 102 may be unselected (e.g., by clocking) by a user using a mouse, touch screen input, or a similar means. Upon deselection of the linked text 128, the highlighting of the linked component 112 of the object 106 in the virtual model section 104 may be removed. In some example embodiments, the object 106 in the virtual model section 104 may remain in the orientation shown in FIG. 2 or may return to the some shown in FIG. 1 in response to the deselection of the linked text 128.

In some alternative embodiments, the buttons, such as the Back button 202, etc., may appear at different locations than shown without departing from the scope of this disclosure. In some alternative embodiments, the electronic manual 100 may include responsive buttons other than or in addition to those shown in FIG. 2 without departing from the scope of this disclosure.

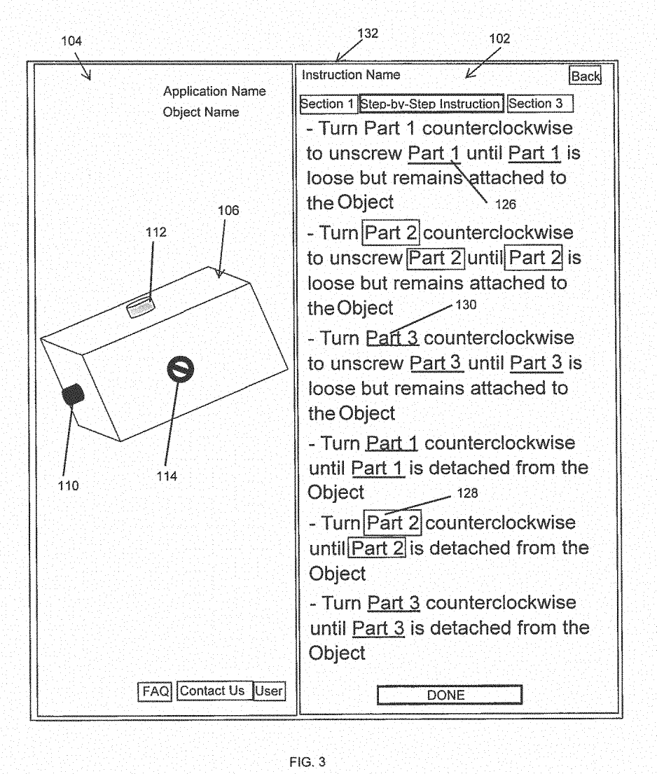

FIG. 3 illustrates the electronic manual 100 of FIG. 2 with the object 106 manipulated by a user to a different position according to an example embodiment. In some example embodiments, a user may rotate, tilt, zoom in and out, and otherwise manipulate the object 106 in the virtual model section 104 to change the view of the object 106 presented in the virtual model section 104. For example, a user may use a mouse or another device connected to the device 132 to manipulate the object 106. To illustrate, a component of the object 106 may be brought into view in the virtual model section 104 by manually manipulating the orientation of the object 106.

In some example embodiments, a user may rotate, tilt, zoom in and out, and otherwise manipulate the object 106 in the virtual model section 104 while a component of the object 106 and occurrences of the corresponding linked text are highlighted. To illustrate, the component 112 of the object 106 and occurrences of the corresponding linked text 128 remain highlighted during the manual manipulation of the object 106 in the virtual model section 104 to the position shown in FIG. 2.

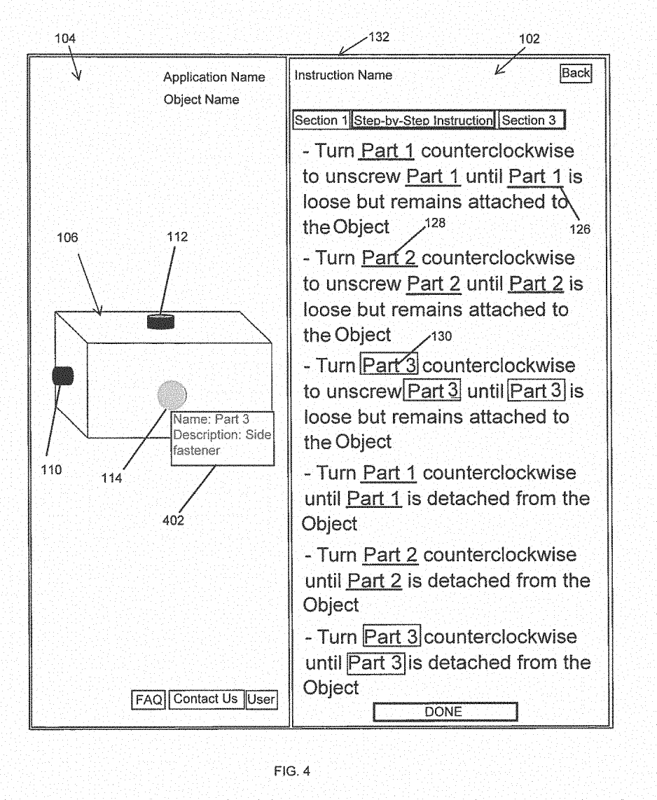

FIG. 4 illustrates the electronic manual 100 of FIG. 1 with occurrences of the linked text 130 in the textual instruction section 102 highlighted according to an example embodiment. In some example embodiments, a description 402 of the component 114 may be displayed in the virtual model section 104 in response to a user selecting the third component 114 of the object 106 in the virtual model section 104. Further, occurrences of the linked text 130 that are linked to the component 114 are highlighted in the textual instruction section 102 in response to the user selecting the third component 114 of the object 106 in the virtual model section 104. By highlighting occurrences of linked text in the textual instruction section 102 that are related to selected component in the virtual model section 104, a user may more efficiently identify instructions in the textual instruction section 102 that are relevant to the selected component.

In some example embodiments, the component 114 of the object 106 may be displayed standalone in the virtual model section 104 with the other components of the object 106 removed from view. The component 114 may also be manipulated in the virtual model section 104 by performing rotating, tilting, and/or zooming in and out of the component 114 to provide different view of the component 114 in the virtual model section 104.

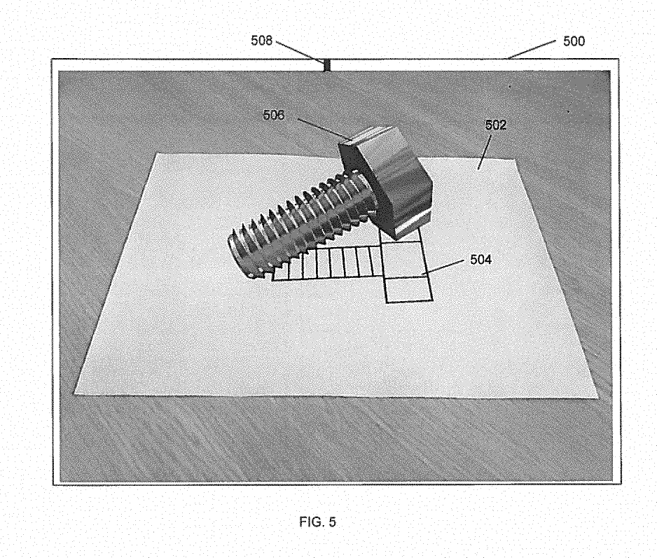

FIG. 5 illustrates an interactive three-dimensional (3D) virtual model 506 of an object that is displayed on a display device 500 based on a two-dimensional (2D) model 504 of the object according to an example embodiment. For example, the 2D model 504 of the object (e.g., a screw) may be drawn on a piece of paper 502. To illustrate, the piece of paper 502 may be a page from a printed blueprint or from a manual. The 3D model of the object may be stored in the display device 500 and retrieved in response to the display device 500 recognizing the object from the two-dimensional (2D) model 504 of the object.

In some example embodiments, the display device 500 may include a camera 508 and/or may be connected to a camera. For example, the display device 500 may be a desktop computer with a monitor, a laptop, a tablet, or another suitable device as can be understood by those of ordinary skill in the art with the benefit of this disclosure.

In some example embodiments, before the 3D model 506 is displayed on the display device 500 as illustrated in FIG. 5, the camera 508 may be pointed on the 2D model 504 of the object by a user to enable the display device 500 to perform to an image recognition operation on the object. For example, the display device 500 may perform comparisons of the image taken by the camera 508 against models (e.g., 2D models) stored in the memory of the display device 500 to retrieve a matching 3D model, for example, from the memory of the display device 500 upon finding a 2D match. Alternatively, the display device 500 may perform comparisons of an identification marking in the 2D model 504 (e.g., a bar code) against information stored in the display device 500 to identify and retrieve a 3D model using AR (augmented reality) software such as Vuforia.

In some example embodiments, after the 3D model 506 of the object is displayed as shown in FIG. 5, the 3D model 506 may be rotated, tilted, and zoomed in and out by a user to provide a desired view of the object. Further, individual components of the object in the 3D model 506 may be selected by the user in a similar manner as described above. For example, a user may use a mouse or a touch screen interface of the display device 500 to manipulate the position and orientation of the object as well as to select components.

The display of the 3D model 506 of an object in contrast to a 2D model 504 of the object may facilitate tasks such as use of the object, maintenance or repair of the object, etc. by providing improved understanding of the object, for example, within the context of instructions provided along with the 2D model 504.

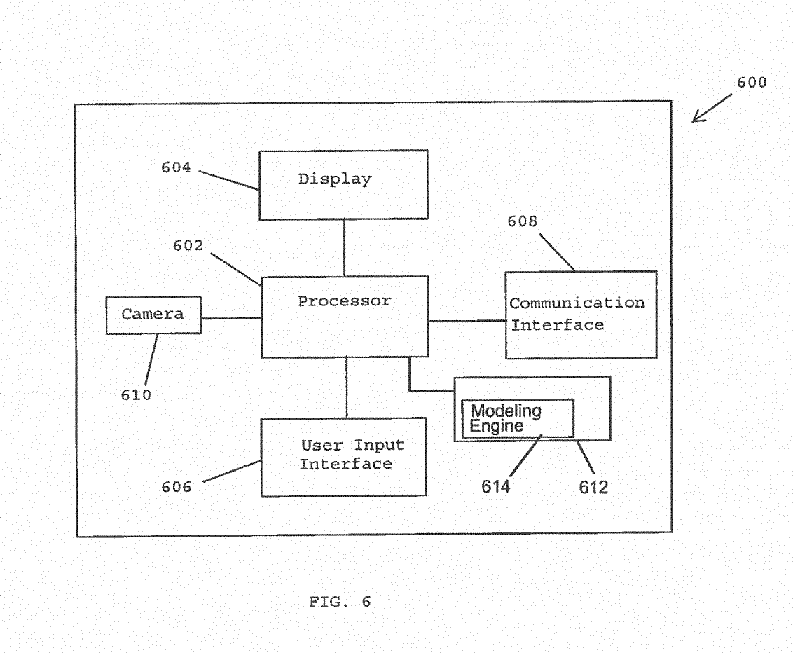

FIG. 6 illustrates a device 600 for providing the electronic manual 100 of FIG. 1 and the virtual 3D model of FIG. 5 according to an example embodiment. For example, the device 600 may correspond to the display device 132 of FIG. 1 and the display device 500 of FIG. 5. In some example embodiments, the device 600 includes a processor 602 and a memory device 612. For example, the processor 602 may be a microprocessor that includes supporting components such as an analog-to-digital converter, a digital-to-analog converter, etc. as can be understood by those of ordinary skill in the art with the benefit of this disclosure. The memory device 612 may be an SRAM or another kind of non-transitory memory device that is used to store software code, data, and/or images, etc. that are used by the device 600 to perform the operations described above with respect to FIG. 1-5. For example, a modeling engine 614 that includes instructions executable by the processor 602 may be stored in the memory device 612. The electronic manual 100 may also be stored in the memory device 612.

In some example embodiments, the device 600 includes a display interface 604 for displaying the electronic manual 100 and models as described above. The device 600 may also include a user input interface 606 for receiving input from a user. For example, the user input interface 606 may be a touch screen of the display interface 604 and/or a keypad and/or mouse interface. The device 600 may also include a communication interface 608 such as a wireless and/or wired network interface to enable the device 600 to communicate with other network or remote devices. For example, the communication interface 608 may be used to enable a user to communicate with remote support party as described above with respect to FIG. 2.

In some example embodiments, the device 600 may also include a camera 610, for example, to enable a user to communicate with a remote support person via a video call. Further, the camera 610 may enable a user to show a physical object to a remote support person while communicating with the remote support via a video call. The camera 610 may also be used to capture an image of a 2D model of an object for image recognition purposes as described with respect to FIG. 5. In some example embodiments, the device 600 may include other components such as a microphone and a speaker.

In some example embodiments, referring to FIGS. 1-6, a method of using the device 600 includes highlighting a component of the object 106 of the virtual model section 104 in response to a selection of a linked text in the textual instruction section 102 of the electronic manual 100. The method may also include rotating the object in the virtual model section 104 to provide an improved view of the component in response to a selection of a linked text in the textual instruction section 102 of the electronic manual 100. The method may also include providing a zoomed in view of the component in response to a selection of a linked text in the textual instruction section 102 of the electronic manual 100. The method may also include tilting the object to provide an improved view of the component in response to a selection of a linked text in the textual instruction section 102 of the electronic manual 100. The method may also include highlighting a linked text in the textual instruction section 102 in response to a selection of a component of the object 106 in the virtual model section 104.

In some example embodiments, the processor 602 may execute the instructions of the modeling engine 614 to retrieve an electronic manual 100 from the memory device 612 and display the electronic manual 100 on the display interface 604 of a display device 600. As described above, the electronic manual 100 includes a textual instruction section and a virtual model section, where the virtual model section includes a 3D virtual model of an object. The processor 602 may also execute the instructions of the modeling engine 614 to receive from the input interface 606 a user input selecting a linked text displayed in the textual instruction section. The processor 602 may also execute the instructions of the modeling engine 614 to identify, in response to receiving the user input selecting the linked text, a component (e.g., the component 112 shown in FIG. 1) of the object in the 3D virtual model that is linked to the linked text. The processor 602 may also execute the instructions of the modeling engine 614 to highlight, for example, in response to identifying the component (e.g., the component 112 as shown in FIG. 2) of the object in the 3D virtual model, the component of the object in the 3D virtual model displayed on the display interface 604 of the display device 600.

In some example embodiments, the processor 602 may execute the instructions of the modeling engine 614 to receive a user input selecting a component (e.g., the component 114 shown in FIG. 1) of the object in the 3D virtual model and to identify, in response to receiving the user input selecting the component of the object in the 3D virtual model, a linked text in the textual instruction section that is linked to the component of the object in the 3D virtual model. The processor 602 may also execute the instructions of the modeling engine to highlight, in response to identifying the component of the object in the 3D virtual model, the linked text (e.g., the linked text 130 as shown in FIG. 4) in the textual instruction section displayed on display interface of the display device. The processor 602 may execute the instructions of the modeling engine to perform other operations described herein as can be readily understood by those of ordinary skill in the art with the benefit of this disclosure.

Although particular embodiments have been described herein in detail, the descriptions are by way of example. The features of the example embodiments described herein are representative and, in alternative embodiments, certain features, elements, and/or steps may be added or omitted. Additionally, modifications to aspects of the example embodiments described herein may be made by those skilled in the art without departing from the spirit and scope of the following claims, the scope of which are to be accorded the broadest interpretation so as to encompass modifications and equivalent structures.

What is claimed is:

1. A non-transitory computer-readable medium comprising instructions that when executed by a processor display an electronic manual on a display interface of a display device, the instructions comprising:
retrieving an electronic manual from a memory device;
displaying the electronic manual on a display interface of a display device, the electronic manual comprising a textual instruction section and a virtual model section, wherein the virtual model section includes a 3D virtual model of an object;
receiving from an input interface device a user input selecting a linked text displayed in the textual instruction section;
identifying, in response to receiving the user input selecting the linked text, a component of the object in the 3D virtual model that is linked to the linked text; and
highlighting, in response to identifying the component of the object in the 3D virtual model, the component of the object in the 3D virtual model displayed on display interface of the display device.

2. The non-transitory computer-readable medium of claim 1, wherein the instructions further comprise highlighting the linked text in response to identifying the component of the object in the 3D virtual model.

3. The non-transitory computer-readable medium of claim 1, wherein the instructions further comprise:
receiving from a input interface device a second user input selecting the component of the object in the 3D virtual model;
identifying, in response to receiving the second user input selecting the component of the object in the 3D virtual model, a linked text in the textual instruction section that is linked to the component of the object in the 3D virtual model; and
highlighting the linked text in the textual instruction section in response to identifying the linked text in the textual instruction section.

4. The non-transitory computer-readable medium of claim 1, wherein the instructions further comprise highlighting multiple occurrences of the linked text in the textual instruction section displayed on the display interface of the display device.

5. The non-transitory computer-readable medium of claim 1, wherein the instructions further comprise rotating the object in the 3D virtual model in response to identifying the component of the object in the 3D virtual model.

6. The non-transitory computer-readable medium of claim 5, wherein the instructions further comprise displaying a zoomed in view of the component of the object in the 3D virtual model in response to identifying the component of the object in the 3D virtual model.

7. The non-transitory computer-readable medium of claim 1, wherein the instructions further comprise tilting the object in the 3D virtual model in response to identifying the component of the object in the 3D virtual model.

8. The non-transitory computer-readable medium of claim 1, wherein the textual instruction section includes operating instructions related to the object and wherein the operating instructions include the linked text.

9. The non-transitory computer-readable medium of claim 8, wherein the linked text includes a name of the component.

10. A method of providing an electronic manual with three-dimensional (3D) virtual models, the method performed by a computer-readable modeling engine comprising instructions executed by a processor, the method comprising:
retrieving, by the computer-readable modeling engine, an electronic manual from a memory device;
displaying, by the computer-readable modeling engine, the electronic manual on a display interface of a display device, the electronic manual comprising a textual instruction section and a virtual model section, wherein the virtual model section includes a 3D virtual model of an object;
receiving, by a user interface of the display device, a user input selecting a linked text displayed in the textual instruction section;
identifying, by the computer-readable modeling engine, in response to receiving the user input selecting the linked text, a component of the object in the 3D virtual model that is linked to the linked text; and
highlighting, by the computer-readable modeling engine, in response to identifying the component of the object in the 3D virtual model, the component of the object in the 3D virtual model displayed on display interface of the display device.

11. The method of claim 10, wherein the linked text includes a name of the component.

12. The method of claim 10, further comprising rotating the object in response to the user input selecting the linked text.

13. The method of claim 12, further comprising providing a zoomed in view of the object in response to receiving the user input selecting the linked text.

14. The method of claim 10, further comprising tilting the object in response to receiving the user input selecting the linked text.

15. The method of claim 10, further comprising highlighting multiple occurrences of the linked text in response to receiving the user input selecting the linked text.

16. A method of providing an electronic manual with three-dimensional (3D) virtual models, the method performed by a computer-readable modeling engine comprising instructions executed by a processor, the method comprising:
retrieving, by the computer-readable modeling engine, an electronic manual from a memory device;
displaying, by the computer-readable modeling engine, the electronic manual on a display interface of the display device, the electronic manual comprising a textual instruction section and a virtual model section, wherein the virtual model section includes a 3D virtual model of an object;
receiving, by a user interface of the display device, a user input selecting a component of the object in the 3D virtual model;
identifying by the computer-readable modeling engine, in response to receiving the user input selecting the component of the object in the 3D virtual model, a linked text in the textual instruction section that is linked to the component of the object in the 3D virtual model; and
highlighting, by the computer-readable modeling engine, in response to identifying the component of the object in the 3D virtual model, the linked text in the textual instruction section displayed on display interface of the display device.

17. The method of claim 16, further comprising highlighting, by the user interface of the display device, multiple occurrences of the linked text in response to receiving the user input selecting the component of the object in the 3D virtual model.

18. The method of claim 16, wherein the linked text includes a name of the component.

19. The method of claim 16, further comprising:
receiving, by the computer-readable modeling engine, a second user input from the user interface of the display device; and
rotating the object in response to receiving the second user input.

20. The method of claim 19, further comprising:
receiving, by the computer-readable modeling engine, a third user input from the user interface of the display device; and
providing a zoomed in view of the object in response to receiving the third user input.
